(19) United States
(12) Patent Application Publication
(10) Pub. No.: US 2019/0145151 A1
(43) Pub. Date: May 16, 2019

(54) CONTROL APPARATUS CONTROLLING OPENING AND CLOSING MEMBER FOR VEHICLE

(71) Applicant: AISIN SEIKI KABUSHIKI KAISHA, Kariya-shi (JP)

(72) Inventors: Taishi IIKAWA, Okazaki-shi (JP); Ryo ASANO, Kariya-shi (JP)

(73) Assignee: AISIN SEIKI KABUSHIKI KAISHA, Kariya-shi (JP)

(21) Appl. No.: 16/190,221

(22) Filed: Nov. 14, 2018

(30) Foreign Application Priority Data
Nov. 14, 2017 (JP) 2017-219245

(51) Int. Cl. E05F 15/73; E05F 15/611

(52) U.S. Cl. CPC E05F 15/73; H02P 29/00; E05F 15/611

(57) ABSTRACT

A control apparatus controlling an opening and closing member for a vehicle includes a motor driving portion, a contact determination portion, a speed setting portion specifying a target speed and a determination speed of the opening and closing member in a manner that a difference therebetween changes depending on an opening degree of the opening and closing member, and an opening degree setting portion specifying a stop opening degree of the opening and closing member. In a case where a deceleration stop control is performed, the speed setting portion is configured to decrease the target speed from a deceleration start opening degree to the stop opening degree with increase of the opening degree, the speed setting portion being configured to decrease the determination speed from the deceleration start opening degree to the stop opening degree as compared to a case where the deceleration stop control is not performed.

### CROSS REFERENCE TO RELATED APPLICATIONS

This application is based on and claims priority under 35 U.S.C. § 119 to Japanese Patent Application 2017-219245, filed on Nov. 14, 2017, the entire content of which is incorporated herein by reference.

### TECHNICAL FIELD

This disclosure generally relates to a control apparatus controlling an opening and closing member for a vehicle.

### BACKGROUND DISCUSSION

JP2014-189992A, which is hereinafter referred to as Reference 1, discloses an opening and closing member control apparatus (a control apparatus controlling an opening and closing member for a vehicle) provided at an opening and closing member driving mechanism which drives the opening and closing member to open and close by driving of a motor. The opening and closing member control apparatus disclosed in Reference 1 determines whether or not a foreign object is caught in the opening and closing member based on a comparison between a rotation speed of the motor and a predetermined threshold value. According to the opening and closing member control apparatus disclosed in Reference 1, the aforementioned threshold value varies depending on a position (i.e., an opening degree) of the opening and closing member so that a detection sensitivity increases when the opening and closing member is disposed at a position where possibility that the foreign object is caught in the opening and closing member is high.

In opening the opening and closing member, a user of a vehicle may expect or want the opening and closing member to stop before a fully open position thereof. For example, when a tailgate serving as an example of the opening and closing member is opened to the fully open position in a state where the vehicle is parked in a garage with a low height from a floor to a ceiling, the tailgate may contact the ceiling. Thus, in this case, the tailgate that is opening may be necessary stopped at a position at which the tailgate is inhibited from making contact with the ceiling.

Nevertheless, in the aforementioned opening and closing member control apparatus disclosed in Reference 1, when the opening and closing member is stopped before the fully open position, determination that the foreign object is caught in the opening and closing member may not be appropriately conducted because of the threshold value for determination which is specified on a basis of the position of the opening and closing member. For example, in a case where the motor speed is reduced so as to stop the opening and closing member before the fully open position, the rotation speed of the motor may fall below the threshold value. In this case, a wrong determination that the foreign object is caught in the opening and closing member may be made even though the foreign object is not actually caught.

The aforementioned circumstances may also occur in a control apparatus controlling an opening and closing member for a vehicle which determines whether or not the opening and closing member makes contact with an obstacle besides a control apparatus controlling an opening and closing member for a vehicle which determines whether or not an obstacle is caught in the opening and closing member.

A need thus exists for a control apparatus controlling an opening and closing member for a vehicle which is not susceptible to the drawback mentioned above.

### SUMMARY

According to an aspect of this disclosure, a control apparatus controlling an opening and closing member for a vehicle, the opening and closing member being opened by driving of a motor, the control apparatus includes a motor driving portion driving the motor to bring an opening speed of the opening and closing member to be equal to a target speed, a contact determination portion determining a contact between the opening and closing member and an obstacle in a case where the opening speed of the opening and closing member is smaller than a determination speed which is smaller than the target speed, a speed setting portion specifying the target speed and the determination speed in a manner that a difference between the target speed and the determination speed changes depending on an opening degree of the opening and closing member, and an opening degree setting portion specifying a stop opening degree which serves as the opening degree of the opening and closing member at a time when an opening operation of the opening and closing member is finished. In a case where a deceleration stop control is performed, the deceleration stop control controlling the opening and closing member during the opening operation to stop at the stop opening degree by decelerating the opening operation of the opening and closing member from a deceleration start opening degree thereof which is smaller than the stop opening degree, the speed setting portion is configured to decrease the target speed from the deceleration start opening degree to the stop opening degree of the opening and closing member in conjunction with increase of the opening degree of the opening and closing member, the speed setting portion being configured to decrease the determination speed from the deceleration start opening degree to the stop opening degree of the opening and closing member as compared to a case where the deceleration stop control is not performed.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle including a control apparatus controlling an opening and closing member for a vehicle according to an embodiment disclosed here;

FIG. 2 is a graph illustrating a target rotation speed and a determination rotation speed specified depending on an opening degree of a tailgate; and

FIG. 3 is a flowchart illustrating a flow of a process performed by the control apparatus during an opening operation of the tailgate.

### DETAILED DESCRIPTION

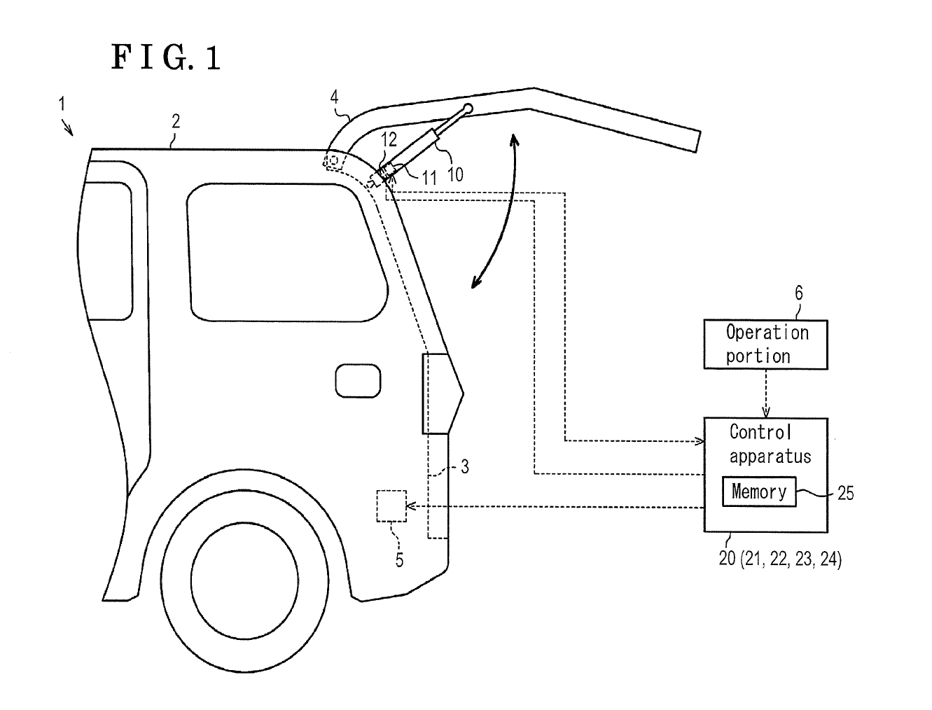

An embodiment of a control apparatus controlling an opening and closing member for a vehicle (which is hereinafter also referred to as a control apparatus) is explained with reference to the attached drawings. As illustrated in FIG. 1, a vehicle 1 includes a body 2 and a tailgate 4 serving as an example of an opening and closing member. The tailgate 4 opens and closes a door opening portion 3 which opens in the rear of the body 2. The vehicle 1 also includes a lock apparatus 5 configured to lock the tailgate 4 to the body 2, an operation portion 6 operated by a user (an operator) for opening or closing the tailgate 4, an actuator 10 driving the tailgate 4, and a control apparatus 20 controlling the actuator 10.

The tailgate 4 is supported at the body 2 to be pivotable or rotatable between a fully closed position at which the door opening portion 3 is closed and a fully open position at which the door opening portion 3 is opened. The tailgate 4 includes a rotary shaft at a base end portion at which the tailgate 4 is supported at the body 2, the rotary shaft extending in a width direction of the vehicle. Therefore, the tailgate 4 pivots or rotates from the fully closed position to the fully open position so that a tip end portion of the tailgate 4 which is positioned opposite to the base end portion supported at the body 2 moves in an arc.

The lock apparatus 5 selectively locks the tailgate 4 disposed at the fully closed position to the body 2 (i.e., a locked state) and unlocks the tailgate 4 from the body 2 (i.e., an unlocked state). The locked state and the unlocked state of the tailgate 4 are switchable therebetween in response to an operation of the operation portion 6 or a portable device by the user.

The operation portion 6 is a push switch, for example, which outputs an operation signal to the control apparatus 20 in a case where the operation portion 6 is operated by the user. The operation portion 6 may be provided at the tailgate 4, a console of the vehicle 1 or the portable device, for example.

The actuator 10 includes a motor 11 serving as a drive source and a rotation angle sensor 12 outputting a pulse signal which is in synchronization with the rotation of the motor 11. The actuator 10 serves as a direct operated actuator which extends and retracts on a basis of the rotation of the motor 11. The actuator 10 includes a first end and a second end in a longitudinal direction, the first end being coupled to the body 2 and the second end being coupled to the tailgate 4. In the actuator 10, the first end is rotatable to the body 2 and the second end is rotatable to the tailgate 4. The actuator 10 applies a force to the tailgate 4 to open the tailgate 4 while extending and applies a force to the tailgate 4 to close the tailgate 4 while retracting.

Accordingly, the tailgate 4, the actuator 10 and the control apparatus 20 collectively constitute a power tailgate apparatus. In the embodiment, an amount of rotation of the motor 11 is proportional to an amount of expansion and retraction of the actuator 10, which results in a correlation with an amount of pivotal movement of the tailgate 4. In the same manner, a rotation speed (which is hereinafter referred to as a rotation speed N) of the motor 11 is proportional to an extension and retraction speed of the actuator 10, which results in a correlation with an opening speed (pivotal moving speed) of the tailgate 4. Thus, in the embodiment, the amount of rotation and the rotation speed of the motor 11 are variables indicating examples of the amount of pivotal movement and the opening speed of the tailgate 4.

Details of control performed by the control apparatus 20 relative to the tailgate 4 are explained. The control apparatus 20 receives the pulse signal which is in synchronization with the rotation of the motor 11 from the rotation angle sensor 12 and the operation signal indicating a request by the user to operate the tailgate 4 (i.e., an operation request) from the operation portion 6. The control apparatus 20 calculates the rotation amount and the rotation speed N of the motor 11 and calculates an opening degree (position) of the tailgate 4, for example, based on the pulse signal. The control apparatus 20 controls operation start timing of the tailgate 4 based on the operation signal. The operation signal includes, for example, signals for opening the tailgate 4, closing the tailgate 4, and stopping the tailgate 4 which is opening or closing, for example.

The control apparatus 20 includes a motor driving portion 21 driving the motor 11 so that the rotation speed N of the motor 11 becomes equal to a target rotation speed (which is hereinafter also referred to as a target rotation speed Ntg) and a contact determination portion 22 determining a contact between the tailgate 4 that is opening (in an opening operation) and an obstacle based on a determination rotation speed (which is hereinafter also referred to as a determination rotation speed Nth). The control apparatus 20 also includes a speed setting portion 23 setting or specifying the target rotation speed Ntg and the determination rotation speed Nth, an opening degree setting portion 24 setting or specifying an opening degree (opening angle) of the tailgate 4 obtained when the opening operation of the tailgate 4 is finished (i.e., a stop opening degree), and a memory 25 which stores various control variables.

The motor driving portion 21 regulates a voltage applied to the motor 11 based on a difference between the rotation speed N (i.e., present rotation speed) of the motor 11 and the target rotation speed Ntg. Specifically, in a case where the rotation speed N of the motor 11 is lower than the target rotation speed Ntg, the motor driving portion 21 increases the voltage applied to the motor 11. In a case where the rotation speed N of the motor 11 is higher than the target rotation speed Ntg, the motor driving portion 21 decreases the voltage applied to the motor 11. In addition, the motor driving portion 21 starts application of the voltage to the motor 11 in a case where an operation start condition of the tailgate 4 is satisfied and stops application of the voltage to the motor 11 in a case where an operation end condition of the tailgate 4 is satisfied.

The operation start condition of the tailgate 4 is satisfied in a case where the operation signal from the operation portion 6 is input to the control apparatus 20, for example. The operation end condition is satisfied in a case where the contact determination portion 22 determines that the tailgate 4 in the opening operation makes contact with the obstacle or in a case where the tailgate 4 completes opening to the stop opening degree, for example. In the embodiment, the obstacle corresponds to an object positioned within a pivotal movement range of the tailgate 4 and includes a human, a wall, a ceiling and the other vehicles, for example.

In a case where the tailgate 4 in the opening operation makes contact with the obstacle, the opening speed of the tailgate 4 decreases, which decreases the rotation speed N of the motor 11. The contact determination portion 22 performs a contact determination of the tailgate 4 based on a decrease amount of the rotation speed N of the motor 11. Specifically, in a case where the rotation speed N of the motor 11 is equal to or greater than the determination rotation speed Nth, i.e., in a case where the rotation speed N of the motor 11 is inhibited from deviating from the target rotation speed Ntg, the contact determination portion 22 determines that the tailgate 4 does not make contact with the obstacle. On the other hand, in a case where the rotation speed N of the motor 11 is smaller than the determination rotation speed Nth, i.e., in a case where the rotation speed N of the motor 11 deviates from the target rotation speed Ntg, the contact determination portion 22 determines that the tailgate 4 makes contact with the obstacle.

The target rotation speed Ntg and the determination rotation speed Nth may be appropriately specified on a basis of request characteristics in the opening operation of the tailgate 4. For example, the target rotation speed Ntg may be determined so that the desired opening operation of the tailgate 4 is obtainable. The determination rotation speed Nth may be determined depending on detection ability of the contact determination of the tailgate 4. In the embodiment, the target rotation speed Ntg serves as an example of a variable indicating a target speed and the determination rotation speed Nth serves as an example of a variable indicating a determination speed.

The speed setting portion 23 specifies the target rotation speed Ntg and the determination rotation speed Nth so that the difference therebetween changes depending on the opening degree of the tailgate 4. The speed setting portion 23 specifies the target rotation speed Ntg and the determination rotation speed Nth so that the target rotation speed Ntg is greater than the determination rotation speed Nth with any opening degree of the tailgate 4.

The opening degree setting portion 24 may change the stop opening degree based on a switch operation for changing the stop opening degree or may change the stop opening degree based on a switch operation for memorizing or storing a predetermined opening degree of the tailgate 4 as the stop opening degree in a state where the tailgate 4 is maintained at the predetermined opening degree. The opening degree setting portion 24 thus changes the opening degree of the tailgate 4 at which the opening operation of the tailgate 4 is finished to a desired opening degree of the user.

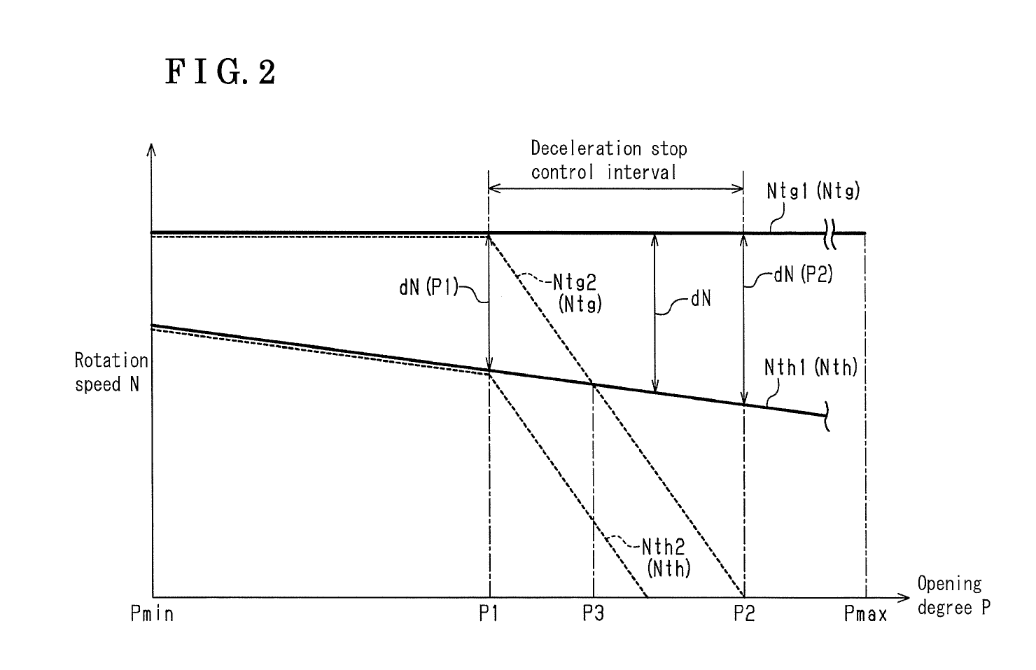

Details of the target rotation speed Ntg and the determination rotation speed Nth of the motor 11 are explained with reference to FIG. 2. In FIG. 2, the target rotation speed Ntg (Ntg1) and the determination rotation speed Nth (Nth1) in a case where a deceleration stop control which is explained later is not performed are indicated by a solid line. In addition, in FIG. 2, the target rotation speed Ntg (Ntg2) and the determination rotation speed Nth (Nth2) in a case where the deceleration stop control is performed are indicated by a dotted line.

As illustrated by the solid line in FIG. 2, the target rotation speed Ntg1 of the motor 11 and the determination rotation speed Nth1 of the motor 11 are specified on a basis of an opening degree P of the tailgate 4. In the embodiment, the target rotation speed Ntg1 of the motor 11 is specified to a constant value within a range from a minimum opening degree Pmin corresponding to the fully closed position to a maximum opening degree Pmax corresponding to the fully open position. On the other hand, the determination rotation speed Nth1 of the motor 11 is specified to gradually decrease with increase of the opening degree P of the tailgate 4 within the range from the minimum opening degree Pmin to the maximum opening degree Pmax. Thus, an inclination of the target rotation speed Ntg1 relative to the opening degree P is different from an inclination of the determination rotation speed Nth1 relative to the opening degree P. That is, a difference between the target rotation speed Ntg1 and the determination rotation speed Nth1 of the motor 11 gradually increases with increase of the opening degree P of the tailgate 4.

In the tailgate 4, a magnitude of a moment applied around the rotary shaft of the tailgate 4 caused by the weight of the tailgate 4 changes or the amount of pivotal movement of the tailgate 4 per unit rotation amount of the motor 11 changes, for example, with increase of the opening degree P of the tailgate 4. Thus, a decrease amount of the rotation speed N of the motor 11 changes depending on the opening degree P of the tailgate 4 in a state where a constant external force in a direction opposite to an operating direction (i.e., opening direction) of the tailgate 4 is applied to the tailgate 4 that is opening.

As a result, in a case where the difference between the target rotation speed Ntg and the determination rotation speed Nth is constant regardless of the magnitude of the opening degree P of the tailgate 4, for example, a magnitude of an external force necessary for the rotation speed N of the motor 11 to fall below the determination rotation speed Nth changes depending on the opening degree P of the tailgate 4. Therefore, in the embodiment, the determination rotation speed Nth1 of the motor 11 is specified to gradually decrease with increase of the opening degree P of the tailgate 4. As a result, regardless of the opening degree P of the tailgate 4, it is determined that the tailgate 4 makes contact with the obstacle in a case where the same (substantially the same) external force (i.e., a door reaction force) is applied from the obstacle which makes contact with the tailgate 4.

Next, the deceleration stop control, and the target rotation speed Ntg2 and the determination rotation speed Nth2 in a case where the deceleration stop control is performed are explained with reference to FIG. 2. The control apparatus 20 performs the deceleration stop control to stop the tailgate 4 which is opening at a stop opening degree P2 by decelerating the opening operation of the tailgate 4 from a point at which the tailgate 4 is opened at a smaller degree (which is hereinafter also referred to as a deceleration start opening degree P1) than the stop opening degree P2 that is specified by the opening degree setting portion 24. The control apparatus 20 performs the deceleration stop control to add fine quality feeling to the opening operation of the tailgate 4. The deceleration start opening degree P1 may be an opening degree acquired by subtracting a predetermined opening degree from the stop opening degree P2 or may be a desired opening degree of the user in the same manner as the stop opening degree. In the embodiment, in a case where the deceleration stop control is performed, a flag FLG indicating that the deceleration stop control is performed is turned on at the memory 25.

As illustrated by the dotted line in FIG. 2, in a case where the deceleration stop control is performed, the control apparatus 20 (the opening degree setting portion 24) specifies the target rotation speed Ntg2 from the deceleration start opening degree P1 to the stop opening degree P2 to gradually decrease with increase of the opening degree P of the tailgate 4. In the embodiment, the control apparatus 20 linearly decreases the target rotation speed Ntg2. Alternatively, the control apparatus 20 may decrease the target rotation speed Ntg2 in a stepwise manner or may non-linearly decrease the target rotation speed Ntg2.

In a case where the contact determination of the tailgate 4 is performed in a state where the determination rotation speed Nth1 indicated by the solid line in FIG. 2 is employed for the deceleration stop control which is performed on a basis of the target rotation speed Ntg2 indicated by the dotted line in FIG. 2, a possible issue is raised. Specifically, even when the rotation speed N of the motor 11 is controlled to be equal to the target rotation speed Ntg2 indicated by the dotted line in FIG. 2 during the opening operation of the tailgate 4, the rotation speed N of the motor 11 falls below the determination rotation speed Nth1 when the opening degree P of the tailgate 4 is an opening degree P3. Even though the tailgate 4 does not actually make contact with the obstacle, it may be determined that the tailgate 4 makes contact with the obstacle.

Therefore, in the embodiment, the control apparatus 20 (the speed setting portion 23) specifies the determination rotation speed Nth2 from the deceleration start opening degree P1 to the stop opening degree P2 to be smaller than the determination rotation speed Nth1 which is specified for the case where the deceleration stop control is not performed. That is, as illustrated in FIG. 2, the control apparatus 20 controls the determination rotation speed Nth2 from the deceleration start opening degree P1 to the stop opening degree P2 to be smaller than the determination rotation speed Nth1.

Specifically, in a state where a difference between the target rotation speed Ntg1 and the determination rotation speed Nth1 with the tailgate 4 at the arbitrary opening degree P is defined as a difference speed dN, the control apparatus 20 specifies the determination rotation speed Nth2 from the deceleration start opening degree P1 to the stop opening degree P2 to a speed obtained by subtracting the difference speed dN from the determination rotation speed Nth1 which is specified for the case where the deceleration stop control is not performed. In the embodiment, the control apparatus 20 specifies the difference speed dN to be a difference speed dN (P1) serving as a difference with the opening degree P of the tailgate 4 at the deceleration start opening degree P1. Accordingly, as illustrated in FIG. 2, the determination rotation speed Nth2 from the deceleration start opening degree P1 to the stop opening degree P2 specified for the case where the deceleration stop control is performed is in parallel to the target rotation speed Ntg2.

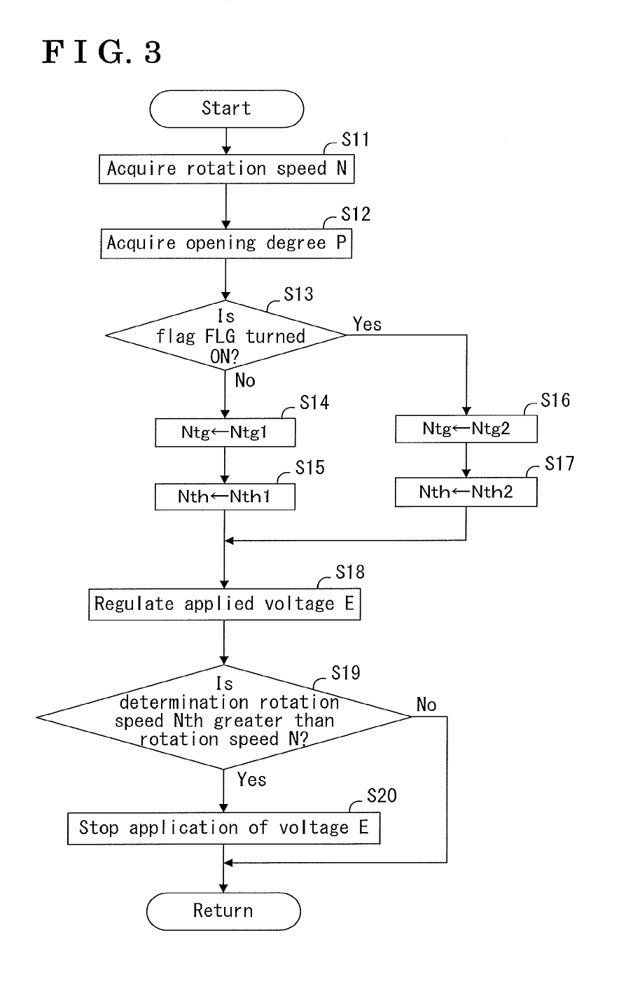

Next, a flow of a process performed by the control apparatus 20 during the opening operation of the tailgate 4 is explained with reference to a flowchart illustrated in FIG. 3. The process is performed each predetermined control cycle during the opening operation of the tailgate 4.

As illustrated in FIG. 3, the control apparatus 20 acquires the rotation speed N of the motor 11 and the opening degree P of the tailgate 4 based on a detection signal (pulse signal) of the rotation angle sensor 12 (step S11 and step S12). Then, the control apparatus 20 determines whether or not the flag FLG stored at the memory 25 is turned on (step S13). In a case where the flag FLG is turned off, i.e., the deceleration stop control is not performed (No in step S13), the control apparatus 20 specifies the target rotation speed Ntg and the determination rotation speed Nth to the target rotation speed Ntg1 and the determination rotation speed Nth1 which are specified for the case where the deceleration stop control is not performed (step S14 and step S15). Afterwards, the control apparatus 20 moves the process to step S18.

On the other hand, in a case where the flag FLG is turned on (Yes in step S13), i.e., in a case where the deceleration stop control is performed, the control apparatus 20 specifies the target rotation speed Ntg and the determination rotation speed Nth to the target rotation speed Ntg2 and the determination rotation speed Nth2 which are specified for the deceleration stop control (step S16 and step S17).

The control apparatus 20 then regulates a voltage E applied to the motor 11 for bringing the rotation speed N of the motor 11 to the target rotation speed Ntg (step S18). Specifically, the control apparatus 20 increases the voltage E applied to the motor 11 in a case where the rotation speed N of the motor 11 is smaller than the target rotation speed Ntg or decreases the voltage E applied to the motor 11 in a case where the rotation speed N of the motor 11 is greater than the target rotation speed Ntg.

The control apparatus 20 then determines whether or not the rotation speed N of the motor 11 is smaller than the determination rotation speed Nth (step S19). When the rotation speed N of the motor 11 is equal to or greater than the determination rotation speed Nth (No in step S19), i.e., it is determined that the tailgate 4 does not make contact with the obstacle, the control apparatus 20 terminates the present process. That is, in this case, the opening operation of the tailgate 4 is continued because the motor 11 is not stopped.

On the other hand, in a case where the rotation speed N of the motor 11 is smaller than the determination rotation speed Nth (Yes in step S19), i.e., it is determined that the tailgate 4 makes contact with the obstacle, the control apparatus 20 stops application of the voltage E to the motor 11 (step S20). That is, in this case, the opening operation of the tailgate 4 is stopped because the motor 11 is stopped.

Effects of the present embodiment are explained as below. According to the present embodiment, the target rotation speed Ntg from the deceleration start opening degree P1 to the stop opening degree P2 of the tailgate 4 is specified smaller in a case where the deceleration stop control is performed as compared to the case where the deceleration stop control is not performed. Thus, when the deceleration stop control is performed in a state where the determination rotation speed Nth1 specified for the case where the deceleration stop control is not performed is employed, for example, instead of the determination rotation speed Nth2 specified for the case where the deceleration stop control is performed, the opening speed of the tailgate 4 may fall below the determination rotation speed Nth1 when the opening speed of the tailgate 4 simply slightly decreases. That is, when the deceleration stop control is performed in a state where the determination rotation speed Nth1 specified for the case where the deceleration stop control is not performed is employed instead of the determination rotation speed Nth2 specified for the deceleration stop control, the control apparatus 20 may wrongly determine that the tailgate 4 makes contact with the obstacle even though the tailgate 4 does not make contact with the obstacle.

According to the present embodiment, the control apparatus 20 specifies the determination rotation speed Nth2 from the deceleration start opening degree P1 to the stop opening degree P2 specified for the case where the deceleration stop control is performed to be smaller than the determination rotation speed Nth1 from the deceleration start opening degree P1 to the stop opening degree P2 specified for the case where the deceleration stop control is not performed. Thus, the opening speed of the tailgate 4 is unlikely to be smaller than the determination rotation speed Nth2 when the opening speed of the tailgate 4 simply slightly decreases in a state where the deceleration stop control is being performed. That is, the control apparatus 20 is unlikely to make a wrong determination that the tailgate 4 makes contact with the obstacle. Thus, the control apparatus 20 may appropriately perform the contact determination of the tailgate 4, i.e., may be unlikely to make a wrong determination of the contact of the tailgate 4, even in a case where the stop opening degree P2 of the tailgate 4 during the opening operation thereof is reduced.

In a case where the difference between the target rotation speed Ntg and the determination rotation speed Nth is large, it may not be determined that the tailgate 4 makes contact with the obstacle unless the opening speed of the tailgate 4 greatly decreases. On the other hand, in a case where the difference between the target rotation speed Ntg and the determination rotation speed Nth is small, it may be determined that the tailgate 4 makes contact with the obstacle without great decrease of the opening speed of the tailgate 4. That is, the difference between the target rotation speed Ntg and the determination rotation speed Nth influences sensitivity of contact determination of the tailgate 4.

According to the present embodiment, as illustrated in FIG. 2, the difference between the target rotation speed Ntg and the determination rotation speed Nth from the deceleration start opening degree P1 to the stop opening degree P2 may be likely to become the same (substantially the same) between the case where the deceleration stop control is performed and the case where the deceleration stop control is not performed. Thus, sensitivity of contact determination of the tailgate 4 may be the same between the case where the deceleration stop control is performed and the case where the deceleration stop control is not performed.

Because the control apparatus 20 specifies the difference speed dN to the difference speed dN (P1), the control apparatus 20 is able to determine the difference speed dN and the determination rotation speed Nth2 (i.e., determine the determination speed specified for the case where the deceleration stop control is performed) at a time when the deceleration start opening degree P1 is determined. Thus, the control apparatus 20 may easily deal with the difference speed dN and the determination rotation speed Nth2 (i.e., deal with the determination speed specified for the case where the deceleration stop control is performed).

In addition, the aforementioned effects are obtainable in the opening operation of the tailgate 4 which may be highly required to reduce the stop opening degree among the opening and closing member.

The present embodiment may be appropriately changed or modified as follows. The present embodiment and the following changes (modifications) may be combined with each other as long as such combination is technically consistent and compatible with each other. The control apparatus 20 may specify the difference speed dN to a difference speed dN (P2) serving as a difference between the target rotation speed Ntg1 and the determination rotation speed Nth1 at the stop opening degree P2 specified for the case where the deceleration stop control is not performed.

As a result, the control apparatus 20 may determine the difference speed dN and the determination rotation speed Nth2 (i.e., determine the determination speed specified for the case where the deceleration stop control is performed) at a time when the stop opening degree P2 is determined. The control apparatus 20 may therefore easily deal with the difference speed dN and the determination rotation speed Nth2 (i.e., deal with the determination speed specified for the case where the deceleration stop control is performed).

In a state where the arbitrary opening degree P greater than the deceleration start opening degree P1 and smaller than the stop opening degree P2 is defined as an opening degree Px, the control apparatus 20 may specify the difference speed dN to a difference speed dN (Px) which is a function of the difference speed dN.

The difference speed dN used for calculation of the determination rotation speed Nth2 may vary depending on the opening degree P. For example, in a state where the opening degree of the tailgate 4 greater than the deceleration start opening degree P1 is defined as an opening degree Px1 and the opening degree of the tailgate 4 greater than the opening degree Px1 and smaller than the stop opening degree P2 is defined as an opening degree Px2, a determination rotation speed Nth2 (Px1) at the opening degree Px1 may be a value obtained by subtracting a difference speed dN (Px1) from a determination rotation speed Nth1 (Px1) and a determination rotation speed Nth2 (Px2) at the opening degree Px2 may be a value obtained by subtracting a difference speed dN (Px2) from a determination rotation speed Nth1 (Px2).

Accordingly, regardless of the opening degree P of the tailgate 4, the difference between the target rotation speed Ntg1 and the determination rotation speed Nth1 specified for the case where the deceleration stop control is not performed may be equal to the difference between the target rotation speed Ntg2 and the determination rotation speed Nth2 specified for the case where the deceleration stop control is performed. That is, sensitivity of contact determination of the tailgate 4 may be the same between the case where the deceleration stop control is not performed and the case where the deceleration stop control is performed.

The control apparatus 20 may specify the target rotation speed Ntg2 for the deceleration stop control to a value obtained by subtracting a value that is obtained by multiplying the arbitrary difference speed dN by a predetermined coefficient from the target rotation speed Ntg1 specified for the case where the deceleration stop control is not performed.

The control apparatus 20 may increase or decrease the target rotation speed Ntg1 of the motor 11 with increase of the opening degree P of the tailgate 4. The control apparatus 20 may increase or stabilize the determination rotation speed Nth1 of the motor 11 with increase of the opening degree P of the tailgate 4.

The control apparatus 20 may employ the opening speed, the target speed and the determination speed of the tailgate 4 instead of the rotation speed N, the target rotation speed Ntg and the determination rotation speed Nth of the motor 11 for the aforementioned control. In this case, the control apparatus 20 may acquire the amount of pivotal movement and the pivotal moving speed of the tailgate 4 based on a detection signal of a rotation amount sensor such as a potentiometer provided at the rotary shaft of the tailgate 4, for example.

The control apparatus 20 may perform the aforementioned control using a speed based on the opening speed, the target speed and the determination speed of the tailgate 4. For example, the control apparatus 20 may perform the control using the expansion and retraction speed of the actuator 10.

The control apparatus 20 may automatically specify the stop opening degree P2 of the tailgate 4 based on a detection signal from a detecting portion which acquires information related to environment of surroundings of the vehicle. Accordingly, the tailgate 4 is unlikely to make contact with the obstacle during the opening operation of the tailgate.

The opening and closing member may be a vehicle door other than the tailgate 4. The opening and closing member may be a swing door or a slide door opening and closing an opening portion provided at a side portion of the vehicle, for example. In addition, the opening and closing member may not be the door for the vehicle. The opening and closing member may be a window glass opening and closing a window opening portion.

According to the aforementioned embodiment, a control apparatus controlling an opening and closing member (tailgate 4) for a vehicle 1, the opening and closing member 4 being opened by driving of a motor 11, the control apparatus 20 includes a motor driving portion 21 driving the motor 11 to bring an opening speed of the opening and closing member 4 to be equal to a target speed Ntg, a contact determination portion 22 determining a contact between the opening and closing member 4 and an obstacle in a case where the opening speed of the opening and closing member 4 is smaller than a determination speed Nth which is smaller than the target speed Ntg, a speed setting portion 23 specifying the target speed Ntg and the determination speed Nth in a manner that a difference between the target speed Ntg and the determination speed Nth changes depending on an opening degree P of the opening and closing member 4, and an opening degree setting portion 24 specifying a stop opening degree P2 which serves as the opening degree P of the opening and closing member 4 at a time when an opening operation of the opening and closing member 4 is finished. In a case where a deceleration stop control is performed, the deceleration stop control controlling the opening and closing member 4 during the opening operation to stop at the stop opening degree P2 by decelerating the opening operation of the opening and closing member 4 from a deceleration start opening degree P1 thereof which is smaller than the stop opening degree P2, the speed setting portion 24 is configured to decrease the target speed Ntg from the deceleration start opening degree P1 to the stop opening degree P2 of the opening and closing member 4 in conjunction with increase of the opening degree P of the opening and closing member 4, the speed setting portion 24 being configured to decrease the determination speed Nth from the deceleration start opening degree P1 to the stop opening degree P2 of the opening and closing member 4 as compared to a case where the deceleration stop control is not performed.

In addition, in the case where the deceleration stop control is performed, the speed setting portion 24 specifies the determination speed Nth from the deceleration start opening degree P1 to the stop opening degree P2 of the opening and closing member 4 to a speed obtained by subtracting a difference speed dN from the determination speed Nth obtained in a state where the deceleration stop control is not performed, the difference speed dN serving as a difference between the target speed Ntg and the determination speed Nth in a state where the opening degree P of the opening and closing member 4 is in a range between the deceleration start opening degree P1 and the stop opening degree P2, the deceleration start opening degree P1 and the stop opening degree P2 being inclusive.

Further, the speed setting portion 24 specifies the difference speed dN to be a difference between the target speed Ntg and the determination speed Nth in a state where the opening degree P of the opening and closing member 4 is equal to the deceleration start opening degree P1 when the deceleration stop control is not performed.

Furthermore, the speed setting portion 24 specifies the difference speed dN to be a difference between the target speed Ntg and the determination speed Nth in a state where the opening degree P of the opening and closing member 4 is equal to the stop opening degree P2 when the deceleration stop control is not performed.

Furthermore, the opening and closing member is a tailgate 4 of the vehicle 1.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A control apparatus controlling an opening and closing member for a vehicle, the opening and closing member being opened by driving of a motor, the control apparatus comprising:
a motor driving portion driving the motor to bring an opening speed of the opening and closing member to be equal to a target speed;
a contact determination portion determining a contact between the opening and closing member and an obstacle in a case where the opening speed of the opening and closing member is smaller than a determination speed which is smaller than the target speed;
a speed setting portion specifying the target speed and the determination speed in a manner that a difference between the target speed and the determination speed changes depending on an opening degree of the opening and closing member; and
an opening degree setting portion specifying a stop opening degree which serves as the opening degree of the opening and closing member at a time when an opening operation of the opening and closing member is finished, wherein
in a case where a deceleration stop control is performed, the deceleration stop control controlling the opening and closing member during the opening operation to stop at the stop opening degree by decelerating the opening operation of the opening and closing member from a deceleration start opening degree thereof which is smaller than the stop opening degree, the speed setting portion is configured to decrease the target speed from the deceleration start opening degree to the stop opening degree of the opening and closing member in conjunction with increase of the opening degree of the opening and closing member, the speed setting portion being configured to decrease the determination speed from the deceleration start opening degree to the stop opening degree of the opening and closing member as compared to a case where the deceleration stop control is not performed.

2. The control apparatus according to claim 1, wherein in the case where the deceleration stop control is performed, the speed setting portion specifies the determination speed from the deceleration start opening degree to the stop opening degree of the opening and closing member to a speed obtained by subtracting a difference speed from the determination speed obtained in a state where the deceleration stop control is not performed, the difference speed serving as a difference between the target speed and the determination speed in a state where the opening degree of the opening and closing member is in a range between the deceleration start opening degree and the stop opening degree, the deceleration start opening degree and the stop opening degree being inclusive in the range.

3. The control apparatus according to claim 2, wherein the speed setting portion specifies the difference speed to be a difference between the target speed and the determination speed in a state where the opening degree of the opening and closing member is equal to the deceleration start opening degree when the deceleration stop control is not performed.

4. The control apparatus according to claim 2, wherein the speed setting portion specifies the difference speed to be a difference between the target speed and the determination speed in a state where the opening degree of the opening and closing member is equal to the stop opening degree when the deceleration stop control is not performed.

5. The control apparatus according to claim 1, wherein the opening and closing member is a tailgate of the vehicle.
